(19) United States
(12) Patent Application Publication
(10) Pub. No.: US 2022/0331935 A1
(43) Pub. Date: Oct. 20, 2022

(54) SOCKETS, AND RELATED TOOLS, INCORPORATING ROTATIONAL MARKINGS

(71) Applicant: Daniel R. Dugan, Maumee, OH (US)

(72) Inventor: Daniel R. Dugan, Maumee, OH (US)

(21) Appl. No.: 17/487,174

(22) Filed: Sep. 28, 2021

Related U.S. Application Data
(60) Provisional application No. 63/176,621, filed on Apr. 19, 2021.

(51) Int. Cl. B25B 13/06; B25B 23/00

(52) U.S. Cl. CPC B25B 13/065; B25B 23/0035

(57) ABSTRACT

A socket for use in tightening or loosening a fastener is provided. The socket includes an outer wall defining a first recess at a first end and a second recess at an opposing second end. The first recess is configured to engage a nut or a head of a fastener for rotation. The second recess is configured to receive a drive member of a socket wrench. The outer wall has an outer surface. A plurality of spaced-apart rotational markings is positioned on the outer surface of the outer wall. The plurality of spaced-apart rotational markings is configured to provide a determination of the angle of rotation of the nut or the head of the fastener.

### RELATED APPLICATIONS

This application claims the benefit of U.S. Provisional Patent Application No. 63/176,621 filed Apr. 19, 2021, the disclosure of which is incorporated herein by reference in its entirety.

### BACKGROUND

A socket wrench (also called a socket spanner and more simply a rachet) is a type of wrench that inserts a drive element into a socket. In turn, a recess in the socket engages a fastener in a manner such as to turn the fastener. The fastener can have various forms, including the non-limiting examples of nuts, bolts, screws and the like. The socket wrench incorporates a reversible ratcheting mechanism which allows a user to pivot the socket wrench back and forth to turn the socket, which is more efficient than removing and repositioning a hand wrench.

In addition to a socket wrench, other common methods of driving sockets include driving tools such as pneumatic impact wrenches, hydraulic torque wrenches, torque multipliers, breaker bars and the like.

The principal advantage of a socket wrench coupled with interchangeable sockets is that, instead of a separate wrench for each of the many different fastener sizes and types, only separate sockets are needed for each size and type of fastener.

One basic form of the portion of the socket engaging a nut or a bolt is a recess defined by walls having a certain form. In certain embodiment, the recess can be defined by wall forming a hexagonal “6-point” recess. In other embodiments, the recess can form a “4-point” recess or a “12-point” recess.

Other sockets can have projecting structures configured to engage corresponding recesses located in the head of the fastener. Non-limiting examples include a socket having a Torx® shaped projection, a Philips shaped projection, a slotted projection, an Allen head shaped projection, a spanner shaped projection, a fluted shaped projection a square shaped projection and the like.

The socket is typically attached to the driving tool via a male/female square connection fitting (often referred to as the square drive). Common sizes of square drives include ¼, ⅜, ½, ¾, 1, 1½, 2½ and 3 3/2 inches. This wide range of square drive sizes provides for a wide variety of socket types and sizes to suit small to very large fasteners.

In certain instances, the fastener to be tightened by the socket wrench and socket has tightening specifications. That is, for proper fastening, the fastener must be tightened to a specific torque, often measured in increments of ft-lbs, in order to develop a sufficient clamping load for a proper joint. In other instances, such as the non-limiting example of torque-to-yield fasteners, the fastener is tightened beyond an elastic limit, thereby permanently deforming the fastener. In these instances, the tightening process typically applies additional torque, only this time instead of torque load being measured, the angle of rotation is measured.

It would be advantageous if socket wrenches and their associated sockets could be improved for torque-to-yield fastening processes.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the sockets, and related tools, incorporating rotational markings.

The above objects as well as other objects not specifically enumerated are achieved by a socket for use in tightening a torque-to-yield fastener. The socket includes an outer wall defining a first recess at a first end and a second recess at an opposing second end. The first recess is configured to engage a nut or a head of a fastener for rotation. The second recess is configured to receive a drive member of a socket wrench. The outer wall has an outer surface. A plurality of spaced-apart rotational markings is positioned on the outer surface of the outer wall. The plurality of spaced-apart markings is configured to provide a determination of the angle of rotation of the nut or the head of the fastener.

The above objects as well as other objects not specifically enumerated are also achieved by a method of using a socket to tighten a torque-to-yield fastener. The method includes the steps of defining a first recess of a socket at a first end and a second recess at an opposing second end with an outer wall, the first recess configured to engage a nut or a head of a fastener for rotation, the outer wall having an outer surface, receiving a drive member of a socket wrench within the second recess, positioning a plurality of spaced-apart rotational markings on the outer surface of the outer wall, the plurality of spaced-apart rotational markings configured to provide a determination of the angle of rotation of the nut or the head of the fastener, engaging the nut of the head of the fastener with the second recess, establishing an initial reference line with the spaced-apart markings, rotating the socket in a manner such as to rotate the nut or the head of the fastener and comparing a final reference line with the initial reference line to determine a degree of rotation of the nut or head of the fastener.

The above objects as well as other objects not specifically enumerated are also achieved by a tool for use in tightening a torque-to-yield fastener. The tool includes an outer wall that defines a first recess at a first end and a second recess at an opposing second end. The second recess is configured to receive a drive member of a socket wrench. The outer wall has an outer surface. An extension extends from the first recess and has a projection at a distal end. The projection has a shape and size configured to engage a fastener having a recess of a corresponding shape and size or another socket. A plurality of spaced-apart markings is positioned on the outer surface of the outer wall. The plurality of spaced-apart markings is configured to provide a determination of the angle of rotation of the nut or the head of the fastener.

Various objects and advantages of the sockets, and related tools, incorporating rotational markings will become apparent to those skilled in the art from the following Detailed Description, when read in light of the accompanying drawings.

### BRIEF DESCRIPTION OF THE DRAWINGS

FIG. 1 is a perspective view of a conventional socket wrench and a convention socket.

FIG. 2 is a perspective view of a novel socket in accordance with the invention.

FIG. 3 is a side view of the conventional socket wrench of FIG. 1 fitted with the novel socket of FIG. 2, illustrated in an initial unrotated arrangement.

FIG. 4 is a side view of the conventional rachet of FIG. 1 fitted with the novel socket of FIG. 2, illustrated in a rotated arrangement.

FIG. 5 is a perspective view of a first embodiment of a novel tool in accordance with the invention.

FIG. 6 is a perspective view of a second embodiment of a novel tool in accordance with the invention.

FIG. 7 is a perspective view of a novel socket wrench extension in accordance with the invention.

### DETAILED DESCRIPTION

The sockets, and related tools, incorporating rotational markings will now be described with occasional reference to specific embodiments. The sockets, and related tools, incorporating rotational markings may, however, be embodied in different forms and should not be construed as limited to the embodiments set forth herein. Rather, these embodiments are provided so that this disclosure will be thorough and complete, and will fully convey the scope of the sockets, and related tools, incorporating rotational markings to those skilled in the art.

Unless otherwise defined, all technical and scientific terms used herein have the same meaning as commonly understood by one of ordinary skill in the art to which the sockets, and related tools, incorporating rotational markings belongs. The terminology used in the description of the sockets, and related tools, incorporating rotational markings herein is for describing particular embodiments only and is not intended to be limiting of the sockets, and related tools, incorporating rotational markings. As used in the description of the sockets, and related tools, incorporating rotational markings and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the sockets, and related tools, incorporating rotational markings. Notwithstanding that the numerical ranges and parameters setting forth the broad scope of the sockets, and related tools, incorporating rotational markings are approximations, the numerical values set forth in the specific examples are reported as precisely as possible. Any numerical values, however, inherently contain certain errors necessarily resulting from error found in their respective measurements.

The description and figures disclose sockets, and related tools, incorporating rotational markings. Generally, the sockets and related tools include a plurality of spaced-apart markings and indicia, configured to provide a quick and easy method of determining the angle of rotation of the fastener.

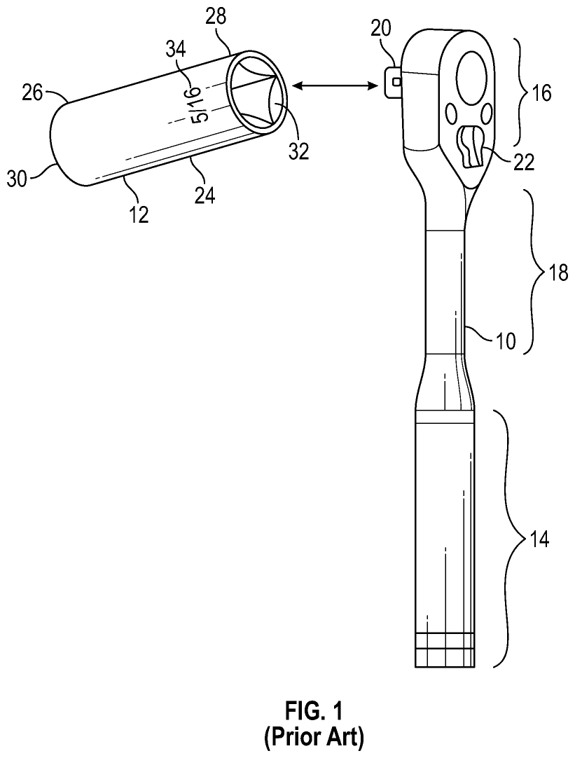

Referring now to the drawings, there is illustrated in FIG. 1, a conventional socket wrench 10 and an accompanying conventional socket 12. As is known in the art, the conventional socket wrench 10 is configured to rotate the conventional socket 12 and thereby impart a rotational force onto a fastener. The socket wrench 10 includes a handle portion 14, a head portion 16 and an intermediate portion 18. The head portion 16 includes a drive member 20 configured for rotation and further configured for engagement with the socket 12. The drive member 20 commonly has a square cross-sectional shape and has a nominal size of ¼, ⅜, ½, ¾, 1, 1½, 2½ and 3½ inches. Optionally, the head portion 16 can include a switch lever 22 configured to change the rotational direction of the drive member 20.

Referring again to FIG. 1, the conventional socket 12 includes an outer wall 24, a first end 26 and a second end 28. The outer wall 24 defines a first recess 30 located at the first end 26 and a second recess 32 located at the second end 28. The first recess 30 is configured to engage a nut or a head of a bolt and has a cross-sectional form, shape and size that approximates a cross-sectional form, shape and size of a nut or head of a bolt. The second recess 32 is configured to engage the drive member 20 and has a cross-sectional form, shape and size that approximates a cross-sectional shape, shape and size of the drive member 20.

Referring again to FIG. 1, in certain instances, the conventional socket 12 can include indicia 34 indicating the size of the first recess 30. Commonly, the size indicated by the indicia is expressed in fractional sizes, such as the non-limiting example of 5/16, or in metric sizes, such as the non-limiting example of 12 mm.

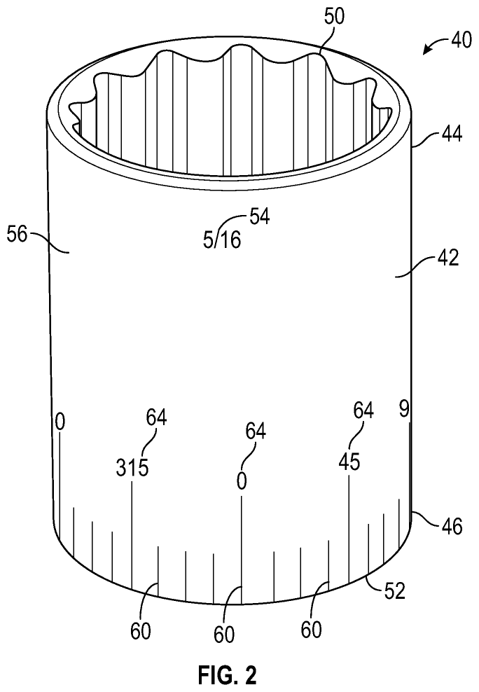

Referring now to FIG. 2, a novel and improved socket is shown generally at 40. The socket 40 is configured for rotation as urged by a conventional socket wrench and is further configured to provide a quick and easy method of determining the angle of rotation of an engaged fastener. The socket 40 includes an outer wall 42, a first end 44 and a second end 46. The outer wall 42 defines a first recess 50 located at the first end 44 and a second recess 52 located at the second end 46. The first recess 50 is configured to engage a nut or a head of a bolt and has a cross-sectional form, shape and size that approximates a cross-sectional form, shape and size of a nut or head of a bolt. The second recess 52 is configured to engage the drive member 20 of the conventional socket wrench 10 and has a cross-sectional form, shape and size that approximates a cross-sectional form, shape and size of the drive member 20.

Referring again to FIG. 2, the first recess 50 can have any desired size and shape sufficient to engage a nut or head of a bolt. Non-limiting examples of a common shape and size of the first recess 50 include a 5/16 inch, “12-point” or a 12 mm “6 point”. The second recess 52 can have any desired size and shape sufficient to engage the drive member 20 in a manner suitable to provide rotation of the socket 10.

Referring again to FIG. 2, in certain instances, the socket 40 can include dimensional indicia 54 indicating the size of the first recess 50. Commonly, the size indicated by the dimensional indicia 54 is expressed in fractional sizes, such as the non-limiting example of 5/16, or in metric sizes, such as the non-limiting example of 12 mm.

Referring again to FIG. 2, the outer wall 42 includes an outer surface 56. The outer surface 56 includes a plurality of spaced-apart markings 60. In operation, as the socket 40 is rotated by the socket wrench 10, the spaced-apart markings 60 are configured to indicate a degree of rotation of the socket 40. In the illustrated embodiment, the spaced-apart marking 60 are located at the second end 46 of the socket 40. In other embodiments, the spaced-apart markings 40 can be positioned at other locations, including the non-limiting examples of the first end 44 of the socket 40 or in between the first and second ends, 44, 46 of the socket 40.

Referring again to the embodiment illustrated in FIG. 2, the spaced-apart markings 60 extend circumferentially around the socket 40 in a continuous manner. However, in other embodiments, the spaced-apart markings 60 can be limited to desired circumferential portions of the socket 40 and/or can form discontinuous circumferential patterns around the socket 40.

Referring again to the embodiment shown in FIG. 2, the spaced-apart markings 60 have the form of line segments, each having an appearance that is readily visible by the user. In alternate embodiments, it is contemplated that the spaced-apart markings 60 can have other forms, such as the non-limiting example of dots, sufficient to be readily visible by the user. It should be appreciated that the spaced-apart markings 60 can be arranged at any desired interval to provide a desired level of rotational precision. As one non-limiting example, the spaced-apart markings 60 can be arranged at intervals of 30°. In another non-limiting example, the spaced-apart markings 60 can be arranged at intervals of 45°.

Referring again to FIG. 2, the spaced-apart markings 60 can have rotational indicia 64 configured to provide a ready reference as to the degree of rotation of the socket 40. One non-limiting example of rotational indicia 64 is shown in the form of rotational degrees of a circle. However, other forms of rotational indicia 64 can be used, sufficient to provide a ready reference as to the amount of rotation of the socket 40.

Referring again to FIG. 2, the spaced-apart markings 60 can be formed in different manners. As one non-limiting example, the spaced-apart markings 60 can be printed on the outer surface 56 of the outer wall 42. In another non-limiting example, spaced-apart markings 60 can be etched into the outer surface 56 of the outer wall 42. In another non-limiting example, spaced-apart markings 60 can be stamped into the outer surface 56 of the outer wall 42. In yet another non-limiting example, spaced-apart markings 60 can have the form of a plurality of stickers, configured for adhesive application to the outer surface 56 of the outer wall 42.

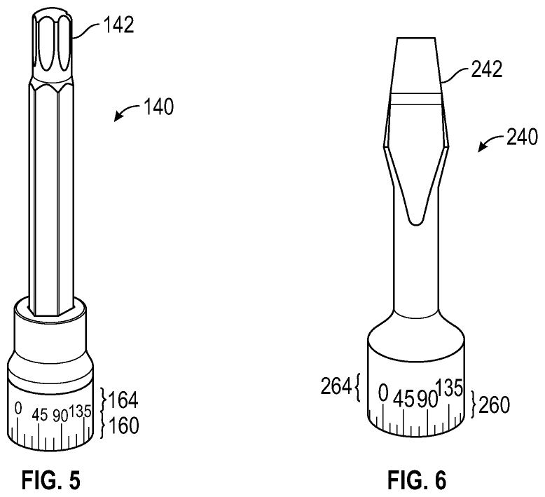

Referring now to FIGS. 4 and 5, operation of the socket 40 will now be described. In an initial step, the conventional socket wrench 10 is connected to the novel socket 40 via the drive member 20 as is known in the art and described above. In a next step, the novel socket 40 is positioned to engage a nut 68 for rotation.

In this initial engagement position, an initial indicia 66 is used to establish an initial reference line 70 relative to the socket wrench 10. In the illustrated embodiment, the initial reference line 70 aligns with the initial indicia 66 labeled as the number “0”. However, it should be appreciated that in other embodiments, other indicia 64 can be used as the initial indicia 66. In a next step, the socket wrench 10 is rotated about the nut 68, thereby causing rotation of the nut 68. As the socket wrench 10 is rotated, the novel socket 40 also rotates, thereby rotating the initial indicia 66 out of alignment with the initial reference line 70. As rotation of the socket wrench is completed, a final reference line and indicia 74 aligns with the initial reference line 70. A comparison of the initial indicia 66 with the final reference line and indicia 74 indicates the degree of angular rotation a of the socket wrench 10 and the novel socket 40. In the embodiment illustrated in FIGS. 4 and 5, the rotation of the socket wrench 10 and the novel socket 40 is in a clockwise direction. However, in other embodiments, the rotation of the socket wrench 10 and the novel socket 40 can be in a counterclockwise direction.

The determination of the angular rotation of the socket wrench 10 and the novel socket 40 can be particularly beneficial in certain assembly operations. One non-limiting example of an assembly operation that could benefit from the novel socket 40 is in torque-to-yield assembly operations. Briefly, torque-to-yield assembly operations involving torqueing a fastener beyond its elastic range, that is past its yield point. The term “yield point” as used herein, is defined to mean past the point from which the bolt material can recover to its original length and into the plastic phase of the bolt material. Torque is further applied in sequence through a series of motions only instead of torque load being measured, an angle of rotation is measured. Advantageously, the novel socket 40 provides a quick and easy method of determining the angle of rotation of the novel socket 40 and an engaged fastener.

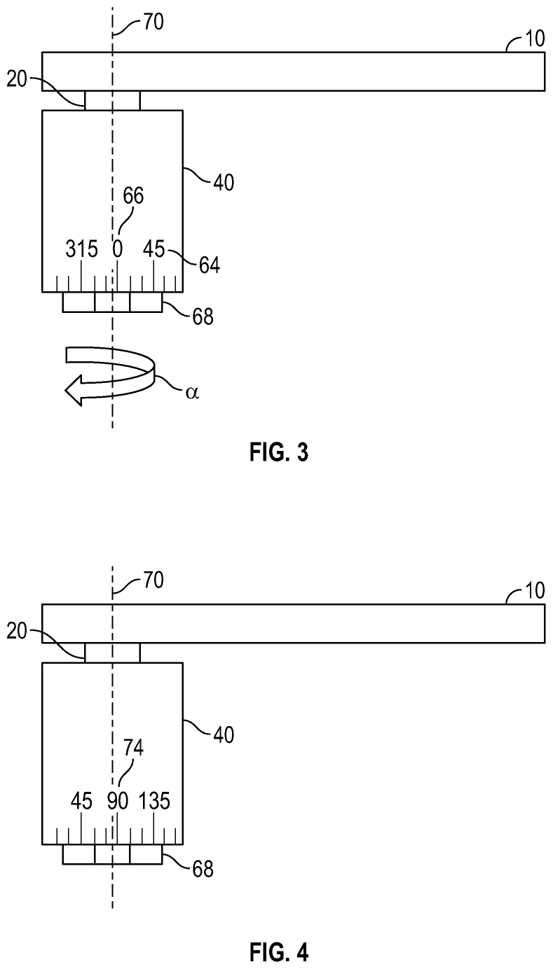

In the embodiment shown in FIGS. 3 and 4, the fastener 68 has the form of a hex-head nut. However, it is contemplated that the head of the fastener 68 can have other forms, including the non-limiting forms of Torx® head fasteners and slotted head screws. In these examples, a novel socket can include the same spaced-apart marking as shown in FIGS. 2-4 and discussed above. Referring now to FIG. 5, a first non-limiting embodiment of an alternate socket 140 is illustrated. The socket 140 is fitted with a Torx® head projection 142 sufficient to engage a fastener fitted with a Torx® head (not shown). The socket 140 also includes a plurality of spaced-apart markings 160 and indicia 164. The spaced-apart markings 160 and the indicia 164 are configured to provide a quick and easy method of determining the angle of rotation of the fastener. In the illustrated embodiment, the spaced-apart markings 160 and indicia 164 are the same as the spaced-apart markings 60 and indicia 64 shown in FIG. 2 and described above. However, in other embodiments, the spaced-apart markings 160 and indicia 164 can be different from the spaced-apart markings 60 and indicia 64.

Referring now to FIG. 6, a second non-limiting embodiment of an alternate socket 240 is illustrated. In this embodiment, the socket 240 is fitted with a slotted screwdriver head projection 242 sufficient to engage a fastener fitted with a slotted, screwdriver type of head (not shown). The socket 240 also includes a plurality of spaced-apart markings 260 and indicia 264. The spaced-apart markings 260 and the indicia 264 are configured to provide a quick and easy method of determining the angle of rotation of the fastener. In the illustrated embodiment, the spaced-apart markings 260 and indicia 264 are the same as the spaced-apart markings 60 and indicia 64 shown in FIG. 2 and described above. However, in other embodiments, the spaced-apart markings 260 and indicia 264 can be different from the spaced-apart markings 60 and indicia 64.

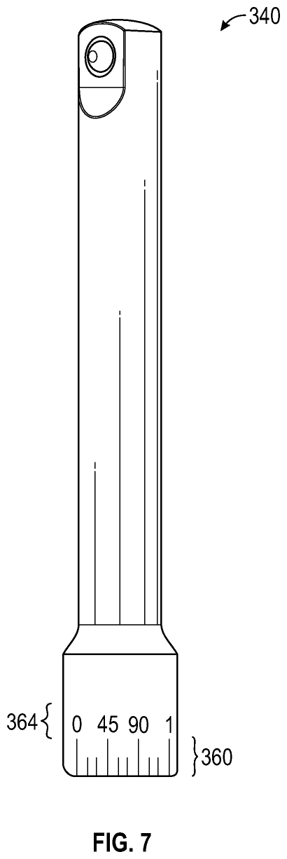

While the embodiments shown in FIGS. 2-6 illustrate the incorporation of spaced-apart markings and indicia to a socket, it is contemplated that in other embodiments, the spaced-apart markings and indicia can be applied to other socket wrench related implements and tools to provide a quick and easy method of determining the angle of rotation of the fastener. Referring now to FIG. 7, a socket wrench extension is illustrated at 340. The socket wrench extension 340 includes a plurality of spaced-apart markings 360 and indicia 364. The spaced-apart markings 360 and the indicia 364 are configured to provide a quick and easy method of determining the angle of rotation of the fastener. In the illustrated embodiment, the spaced-apart markings 360 and indicia 364 are the same as the spaced-apart markings 60 and indicia 64 shown in FIG. 2 and described above. However, in other embodiments, the spaced-apart markings 360 and indicia 364 can be different from the spaced-apart markings 60 and indicia 64.

The sockets, and related tools, incorporating rotational markings provide many benefits, although all benefits may not be available in all embodiments. First, the sockets, and related tools, incorporating rotational markings provide a convenient and easy method of determining the angle of rotation of the fastener. Second, the sockets, and related tools, incorporating rotational markings can be connected to and can be used with conventional tools, such as the non-limiting example of a socket wrench without the use special adapters and without the use of installation tools. Third, the sockets, and related tools, incorporating rotational markings provide all of the functionality and usefulness as conventional sockets and related tools. Fourth, the rotational markings can be adapted to provide a desired level of precision.

In accordance with the provisions of the patent statutes, the principle and mode of operation of the sockets, and related tools, incorporating rotational markings have been explained and illustrated in a certain embodiment. However, it must be understood that the sockets, and related tools, incorporating rotational markings may be practiced otherwise than as specifically explained and illustrated without departing from its spirit or scope.

What is claimed is:

1. A socket for use in tightening a torque-to-yield fastener, the socket comprising:
an outer wall defining a first recess at a first end and a second recess at an opposing second end, the first recess configured to engage a nut or a head of a fastener for rotation, the second recess configured to receive a drive member of a socket wrench, the outer wall having an outer surface; and
a plurality of spaced-apart rotational markings positioned on the outer surface of the outer wall, the plurality of spaced-apart markings configured to provide a determination of the angle of rotation of the nut or the head of the fastener.

2. The socket of claim 1, wherein the socket is configured to torque the fastener past its yield point.

3. The socket of claim 1, wherein the first recess is shaped and sized to receive a 6-point, 0.50 inch nut.

4. The socket of claim 1, wherein the second recess is shaped and sized to receive a square, 0.50 inch drive member.

5. The socket of claim 1, wherein the plurality of spaced-apart rotational markings is positioned adjacent the second end of the outer wall.

6. The socket of claim 1, wherein the plurality of spaced-apart rotational markings extends circumferential around the outer wall in a continuous manner.

7. The socket of claim 1, wherein the plurality of spaced-apart rotational markings extends circumferential around the outer wall in a discontinuous pattern.

8. The socket of claim 1, wherein the plurality of spaced-apart rotational markings has the form of line segments.

9. The socket of claim 1, wherein the plurality of spaced-apart rotational markings is arranged in intervals of 30°.

10. The socket of claim 1, wherein the plurality of spaced-apart rotational markings is formed on the outer surface of the socket by printing.

11. The socket of claim 1, wherein a plurality of indicia is positioned in proximity to the spaced-apart rotational markings and configured to assist in measuring angular rotation.

12. A method of using a socket to tighten a torque-to-yield fastener, the method comprising the steps of:
defining a first recess of a socket at a first end and a second recess at an opposing second end with an outer wall, the first recess configured to engage a nut or a head of a fastener for rotation, the outer wall having an outer surface;
receiving a drive member of a socket wrench within the second recess;
positioning a plurality of spaced-apart rotational markings on the outer surface of the outer wall, the plurality of spaced-apart rotational markings configured to provide a determination of the angle of rotation of the nut or the head of the fastener;
engaging the nut of the head of the fastener with the second recess;
establishing an initial reference line with the spaced-apart rotational markings;
rotating the socket in a manner such as to rotate the nut or the head of the fastener; and
comparing a final reference line with the initial reference line to determine a degree of rotation of the nut or head of the fastener.

13. The method of claim 12, including the step of torquing the fastener past its yield point.

14. The method of claim 12, including the step of forming the spaced-apart rotational markings by printing.

15. The method of claim 12, including the step of positioning a plurality of indicia in proximity to the spaced-apart rotational markings and configuring the plurality of indicia to assist in measuring angular rotation.

16. A tool for use in tightening a torque-to-yield fastener, the tool comprising:
an outer wall defining a first recess at a first end and a second recess at an opposing second end, the second recess configured to receive a drive member of a socket wrench, the outer wall having an outer surface;
an extension extending from the first recess and having a projection at a distal end, the projection having a shape and size configured to engage a fastener having a recess of a corresponding shape and size or another socket; and
a plurality of spaced-apart rotational markings positioned on the outer surface of the outer wall, the plurality of spaced-apart rotational markings configured to provide a determination of the angle of rotation of the nut or the head of the fastener.

17. The tool of claim 16, wherein the tool is configured to torque the fastener past its yield point.

18. The tool of claim 16, wherein the plurality of spaced-apart rotational markings extends circumferential around the outer wall in a continuous manner.

19. The tool of claim 16, wherein the projection has the form of a Torx® head.

20. The tool of claim 16, wherein the projection has the form of a slotted screwdriver.
